(19) United States
(12) Patent Application Publication
(10) Pub. No.: US 2009/0114505 A1
(43) Pub. Date: May 7, 2009

(54) MOVING WALKWAY

(75) Inventors: Miguel Angel Gonzalez Alemany, Oviedo (ES); Juan Domingo Gonzalez Pantiga, Gijon (ES); Manuel Alonso Cuello, Gijon (ES); Jose Ojeda Arenas, Los Fresneda-Siero (ES)

Correspondence Address: MERCHANT & GOULD PC, P.O. BOX 2903, MINNEAPOLIS, MN, 55402-0903, US

(73) Assignees: THYSSENKRUPP ELEVATOR INNOVATION CENTER, S.A., Gijon (ES); THYSSENKRUPP ELEVATOR (ES/PBB) LTD., Staines (GB)

(21) Appl. No.: 12/251,265

(22) Filed: Oct. 14, 2008

(30) Foreign Application Priority Data
Nov. 7, 2007 (ES) 200702957

(51) Int. Cl. B66B 23/12

(52) U.S. Cl. 198/333

(57) ABSTRACT

The invention relates to a moving walkway transporting people on a grooved surface included in pallets (1) having the same pitch as the traction chain, all of them being able to be attached by means of pins (2) forming the actual traction chain between them, in which the pallets (1) are overturned by means of a guide (3) in which only three pallets are located, causing a quick overturning allowing the comb (5) to have sufficient inertia in its ribs (6) so as to support the loads which the users will apply to it in the direction (4).

This application claims benefit of Serial No. 200702957, filed 7 Nov. 2007 in Spain and which application is incorporated herein by reference. To the extent appropriate, a claim of priority is made to the above disclosed application.

### FIELD OF THE INVENTION

The present invention relates to a moving walkway for transporting people formed by a surface moving in the direction of movement and two fixed sections at each of the ends of said walkway, the transition between both being formed by means of a system of combs interlocking with the upper grooves of the moving surface.

The present invention more specifically relates to a system of combs which allows reducing the level difference existing in the transition area between the moving surface forming the pallets and the fixed surface of the moving walkway in which the disembarkation of the users for leaving the walkway is carried out, fulfilling the standard regarding moving walkways and increasing the safety both for pedestrians and for users in wheel chairs or shopping carts.

### BACKGROUND OF THE INVENTION

A very high level difference occurs between the level of the pallets and the level of the disembarkation plates in moving walkways with transitions normally used between the moving areas and the fixed areas. This level difference usually causes a large number of accidents given that the wheels of devices such as wheel chairs or shopping carts come across a large jump upon facing the transition between both areas of the walkway, even causing jamming effects to occur for certain radii of the wheels making the exit of said devices in the moving areas of the walkway impossible.

In addition, when a user on foot comes across the transition between the combs he or she is forced to take a step, which if it does not occur can give rise to a collision with the feet of the user which can unbalance him or her causing an accident.

In a moving walkway according to the traditional concept, the pallets are designed such that they are moved by means of a traction chain such that several chain links are equivalent to the length of a pallet. This chain is overturned at the walkway ends either by means of a wheel comprising at least 15 teeth or by overturning guides comprising at least 7 steps in their run. The consequence of this is that the return of the pallets is too progressive and therefore the structure supporting the system of combs needs to lift with respect to the comb level in order to achieve the necessary inertia, causing the distance necessary for the profile to be sufficiently rigid to be translated into a jump between the pallet level on which the users are placed and the comb plate level corresponding to the disembarkation area.

In a walkway with a traditional pallet, the pallet is hinged at four points supporting the weight of the pallet itself as well as the weight of the actual users. Two of these points are coaxially hinged with the traction chain and another two points are either hinged with a loose support roller which is supported on a guide parallel to that of the chain or with another type of system hinging the pallet with respect to the chain. In any of the designs known in the current state of the art, the end points of the pallet are very far from of the center of the hinge such that when it is overturned, these points lift with respect to the position of the horizontal pallet, causing the line of the disembarkation plates to necessarily be located even higher in order to prevent interference.

These points cannot be located closer to the pin because they would cause interferences of the support rollers or of the hinge of the pallet with the traction chain.

Other solutions such as that of patent U.S. Ser. No. 06/193,056 applied to a system for transporting materials have been proposed in order to reduce the level difference between the level of the moving part and the fixed part by means of a transition carried out with a system of combs. This patent proposes conveyor surfaces attached to one another and with an upper grooving such that the valley of said plate is a circle having a constant radius and that at the time at which said plates engage with the traction wheel, the circle has the hinge pin of said wheel as the center. It is thus achieved that no point of the valley lifts during the overturning, allowing the comb to follow the inner path of the groove and achieving the maximum possible inertia. However, with this solution it may not be possible to achieve the necessary inertia so that the comb supports the load of the vertical weight to which it is subjected due to the fact that the overturning is very progressive and does not leave space to achieve inertia without causing interference with the conveyor plates. In addition, this patent proposes a joint between center concave-convex pallets in the hinge between plates causing sharp groove ends which can be dangerous for the users although they do not represent a danger for transporting materials.

The design of a conveyor plate such as that of the previous patent causes the aesthetics of the conveyor plates to necessarily be determined, forcing the valley of the grooves to be circular and have a radius achieving that its center coincides with the center of the overturning. Likewise, it forces the last seen plate to oscillate between two positions of the valley of the wheel, causing a reduction in the smoothness of the entrance in combs.

A system such as that of patent JP2002003132 proposes the use of a continuous elastic grooved band for transporting people, such band can be downwardly redirected for its entrance in combs with a small radius such that it allows installing combs which do not collide against the grooves of the band of rubber and which achieve sufficient inertia so that they support the vertical load to which the users subject them. This system however forces the use of a band of rubber for transporting the users with the drawbacks that this involves. The bands of rubber make their partial replacement difficult when they are damaged due to use. The solution is either complete restitution or on-site repair which would leave visible marks in the areas that have been worked upon. In addition, these types of walkways usually have strength problems when they are long walkways. With regard to the standard regarding moving walkways, they have problems because their grooves cannot be as high as required because in the overturning high stresses would be generated given their high inertia. Therefore the walkways which are installed with this configuration have grooves lower than those forced by the standard.

### SUMMARY OF THE INVENTION

The object of the concept set forth herein is to eliminate the problems set forth by means of a system of combs reducing the level difference between the moving surface on which the users are placed and the fixed comb plate placed at the same level as the ground on which the moving walkway is installed. The use of the moving walkway by people in wheel chairs and shopping carts without any jamming problem, as well as a smooth transition for pedestrians even in the event that they do not take a step for exiting the moving area, will thus be allowed.

In a walkway according to the present invention, the pallets are much more abruptly overturned than in a walkway according to the traditional concept. The overturning only includes three pallets occupying the return curve, therefore each of them overturns much more quickly, allowing much more inertia for a comb covering the path of the grooves of the pallet both in its upper path and in its valleys.

The comb will therefore have a defined geometry for interlocking with the grooves of the pallet and which follows the paths of the end points of each of them leaving the necessary gap in order to prevent interference. Two paths will therefore be formed in the comb, one of them will follow the path of the points of the valley of the pallet and the other one will follow the path of the points of its crest.

The pallets have gaps between one another in the direction of the walkway in order to allow the pallet to rotate with respect to the next pallet such that they can follow pathways forming a concave band of pallets. This gap causes the grooves between them to begin to open when the pallet starts to overturn such that there is a moment after which the gap becomes dangerous with regard to any entrapment which may occur, after this moment the pallet is not prepared to be accessible by the user and therefore the comb must completely cover it. However the fact that the pallet is already overturned before the combs close it allows such combs to be much shorter and therefore much stronger.

The grooves of the pallets are designed such that they lift as little as possible during the overturning. In order to prevent the lifting effect of the end points each groove is reduced such that it ends as close as possible, as the grooving between pallets allows, to the vertical of the hinge on which the overturning roller is assembled. It is thus achieved that once the comb enters the pallet, the level difference with the line of pallets does not have to be increased.

In addition, the valleys of the grooves between pallets are ended with a shape concentric to the hinge pin, achieving that the pallet does not lift at all in the valley while the overturning occurs, therefore allowing the comb to have the maximum possible inertia.

The traction chain is usually elongated in a moving walkway and therefore a tensioning guide must be placed at one of the heads of the walkway. The system of combs must therefore move with the tensioning guide as this elongation occurs. If the combs are fixed to the structure of the walkway interferences with the pallets will occur due to the fact that by design such combs follow the path of the grooves with the minimum gap in order to prevent interference.

In another preferred arrangement, a horizontal section will be included in the center of the comb with a length equal to half the weight of the pallet. The movement of the combs with the tensioning device is thus not necessary given that a certain run is included to the tensioning such that when the traction chain reaches the end of the tensioning, a return can be made to the initial position by means of removing one link from the circuit.

### BRIEF DESCRIPTION OF THE DRAWINGS

A series of drawings will be very briefly described below which aid in better understanding the invention and which are specifically related to an embodiment of said invention set forth as a non-limiting example thereof.

FIG. 1 is a perspective view of the system of combs with reduced level difference with the pallets attached and overturning on the support rollers

FIG. 2 is a profile view of the comb of the invention interlocked with the pallet following the path of its grooves.

FIG. 3 is a sectional view of the pallet with its groove finishings in order to facilitate the design of the combs.

FIG. 4 is an isometric view of the combs with their lower grooves.

FIG. 5 is an isometric view of the combs in the area of the walkway in which the traction chain is tensioned.

### DETAILED DESCRIPTION OF THE PREFERRED EMBODIMENTS

The invention will be described as it is applied to a moving walkway. However it must be understood that the concepts described in the present specification can be equally applied to other types of transport systems in general and for people in particular.

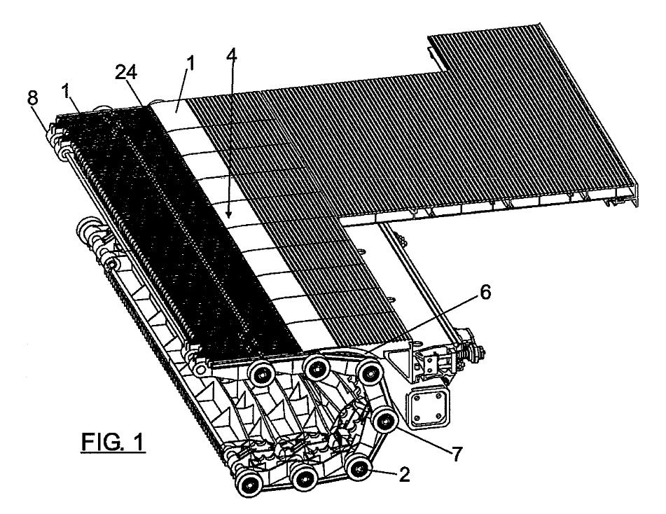

As can been seen in FIG. 1, the walkway transports people on a grooved surface included in several pallets 1 having the same pitch as the traction chain, all of them being able to be attached by means of pins 2 forming the actual traction chain between them.

The pallets 1 are overturned by means of a guide 3 in which only 3 pallets are located, causing a quick overturning allowing the comb 5 to have sufficient inertia in its ribs 6 so as to support the loads which the users will apply in the direction 4.

The pallets are supported on a roller 7 which is assembled coaxially with the pin 2 such that the ends of the pallet hinge with respect to this pin 2 when the pallet 1 is being overturned, forming paths which are a combination of a translation and a rotation.

FIG. 3 shows the finishings of the valleys of the grooving forming a cylindrical surface 8 with the center in the hinge pin in order to achieve that the pallets do not lift in the overturning area, the highest point of the valley 11 of the pallet following a line which will not exceed reference number 10 marked in FIG. 3.

The finishings of the crests 12 of the grooves are ended such that they are as close as possible to the vertical of the pin hinging 13 them, reducing the distance 14 so that interference between two consecutive pallets 15 does not occur. It is thus achieved that the lifting 16 is minimized and with it, the level difference between combs 5 and pallets 1.

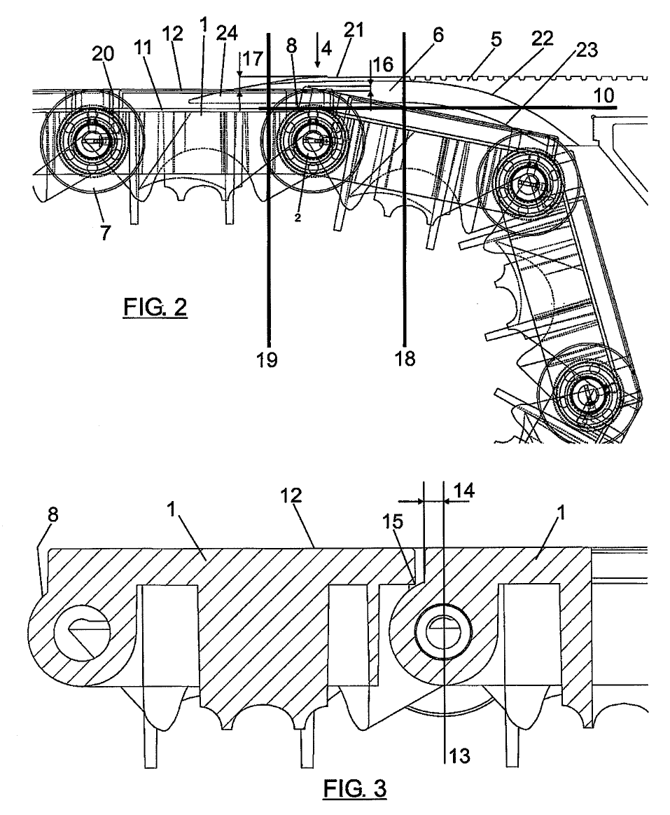

The position of the pallets in the overturning can be seen in FIG. 2. Each pallet 1 is positioned horizontally until its front roller 7 begins to move downwards upon reaching the line 18 from which the overturning begins. At that moment the pallet is still accessible for the user but the gap 20 begins to increase. The comb closing layer 21 therefore beings at the first point in which the gap between pallets exceeds the values given by the standard which occurs at the height of the line 19.

Each groove of the comb will therefore be determined by two curves, the first curve 22 will be designed to not interfere with the crests of the grooves 12 shortened near the vertical of the pin 13 and to prevent the pallet from remaining useful for the users at a point at which the gap between pallets 20 is greater than that allowed.

The lower curve of the comb profiles 23 will follow the path of the highest point of the valley which, due to the fact that these profiles end in a cylindrical shape and coaxial with the pin, is maintained at the same height until the roller of the pallet begins to move downwards to the height of the line 18. At this time the curve 23 begins to move downwards in order to provide the comb 5 with the necessary inertia. The surface comprised between the curve 22 and the curve 23 will form the rib 6 of the combs.

The curve 22 still extends towards the pallet forming prongs 24 aiding any element to carry out a smooth transition with the combs.

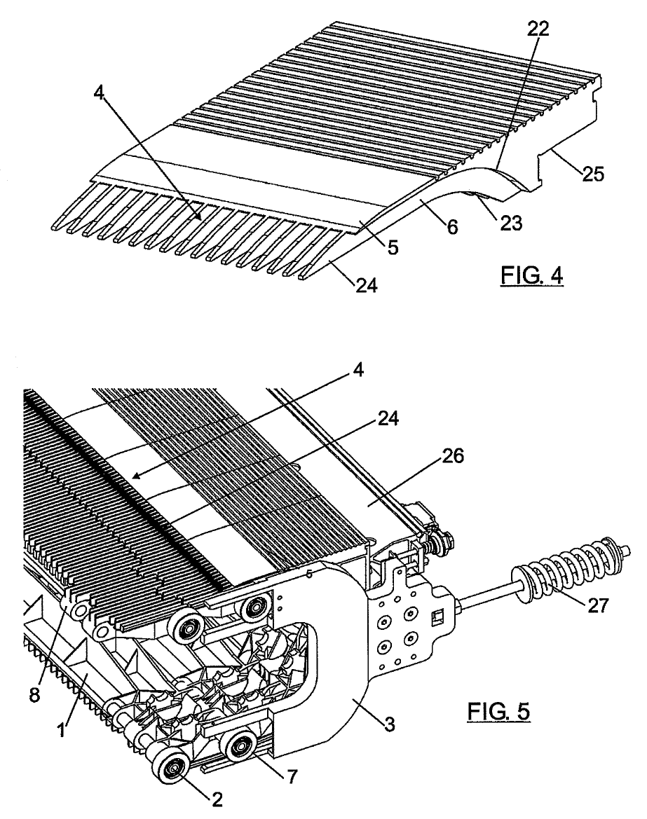

FIG. 4 is an isometric view of the combs which shows an area 25 prepared for the assembly on another support part and fixed either by screws in a vertical direction or in the direction of the movement of the walkway.

As shown in FIG. 5, when the traction chain is tensioned an elongating effect thereof occurs. In this case the assembly formed by the combs 5 with their support structure must move integrally with the overturning guide 3 when the tensioning mechanism 27 acts.

1. A moving walkway formed by a plurality of pallets forming a continuous band with a grooved surface enabled for the users and overturning by means of curves such that 3 or more traction chain links are included in the overturning, wherein the combs copy the path of the groove ends of the pallet both in the valley and in the crest leaving the sufficient gap in order to prevent interference.

2. A walkway according to claim 1, wherein the pallets are attached to one another and hinge with respect to a pin traversing every two consecutive pallets forming the traction chain, a support roller being placed coaxially to said pin.

3. A walkway according to claim 2, wherein the ends of the valleys of the pallets are circular, with a center at the pin hinging them and tangent to the straight surface of said valley.

4. A walkway according to claim 3, wherein the ends of the crests in the grooves of the pallets are vertical and are placed as close as possible, preventing interference between pallets, to the vertical of the pin attaching them.

5. A walkway according to claim 4, wherein the curve determining the lower edge of each rib of the comb follows the path of the valley of the pallets until the necessary point so that the inertia thereof is sufficient to support the weight of the users.

6. A walkway according to claim 5, wherein the curve determining the upper edge of each rib of the comb follows the path of the ends of the crests of the grooving in the pallet.

7. A walkway according to claim 6, wherein above the upper groove of the rib the access to the pallet is closed for the users at the time in which the pallets are overturning such that they open a gap between one another which does not fulfill the standard regarding moving walkways.

8. A walkway according to claim 7, wherein the lower curve of the ribs continues towards the center of the walkway forming a prong allowing the transition between both surfaces to be sufficiently smooth.

9. A walkway according to claim 8, wherein the comb has in its support area a step in order to carry out its assembly on the frame by means of screws which will be placed either vertically or in the direction of movement of the walkway.

10. A walkway according to claim 9, wherein in one or more of the heads of the walkway an overturning guide is placed such that the combs move with said guide as the traction chain is elongated.

11. A walkway according to claim 9, wherein the combs have on their ribs a horizontal path in the direction of forward movement of the pallets, apart from the path of the grooves, with a length equal to at least half the weight of the pallet.

12. A walkway of claim 1, wherein the pallets are overturned by a wheel with 6 or more teeth.
